(19) United States
(12) Patent Application Publication
(10) Pub. No.: US 2022/0288773 A1
(43) Pub. Date: Sep. 15, 2022

(54) SAFE OPERATION OF A MULTI-AXIS KINEMATIC SYSTEM

(71) Applicants: Maximilian Walter, Nürnberg (DE); Dominik Budday, Erlangen (DE); Minh Le, Bernburg (DE); Sören Burmeister, Fürth (DE); Alexander Stein, Veitsbronn (DE)

(72) Inventors: Maximilian Walter, Nürnberg (DE); Dominik Budday, Erlangen (DE); Minh Le, Bernburg (DE); Sören Burmeister, Fürth (DE); Alexander Stein, Veitsbronn (DE)

(21) Appl. No.: 17/691,568

(22) Filed: Mar. 10, 2022

(30) Foreign Application Priority Data
Mar. 11, 2021 (EP) 21162021.6

(51) Int. Cl. B25J 9/16; B25J 9/02

(52) U.S. Cl. CPC B25J 9/1605; B25J 9/023

(57) ABSTRACT

A method for setting up safe operation of a multi-axis kinematic system, a method for safely operating a multi-axis kinematic system, and to an input device for setting up safe operation of a multi-axis kinematic system and a corresponding computer program product. A method includes providing error values of respective axes and ascertaining a compensation value for at least one variable of the safety function on the basis of the error values, on the basis of geometric parameters of the multi-axis kinematic system and on the basis of axis values of the respective axes that are obtained from trajectories of the multi-axis kinematic system.

### CROSS REFERENCE TO RELATED APPLICATIONS

This application claims the benefit of EP 21162021.6 filed on Mar. 11, 2021, which is hereby incorporated by reference in its entirety.

### FIELD

Embodiments relate to a method for setting up safe operation of a multi-axis kinematic system.

### BACKGROUND

In modern production installations and factories, increasing use is being made of robots, handling systems, cranes, etc., or, in general, multi-axis kinematic systems in a wide variety of embodiments. Applications using kinematic systems may equally be found in medical engineering. It is essential for the safety of the operation of such multi-axis kinematic systems in installations that safety-oriented monitoring of the kinematic system or parts of the kinematic system may be implemented. Safe operation of multi-axis kinematic systems is necessary in this case to avoid collisions with objects in the surroundings of the multi-axis kinematic system and for example to avoid dangerous accidents when there are human beings in the surroundings of the multi-axis kinematic system.

For this reason, controllers of robots or manipulators may include monitoring functions, such as for example a monitoring system for a Cartesian speed of a point. The latter involves calculating a Cartesian speed of a point, for example an articulation or the tool center point, from safe axis positions. A check is then performed to determine whether a parameterization of the speed limit has been exceeded. Exceeding is indicated by a safe output.

Similarly, safe zone monitoring is known, that involves calculating a position and an orientation of moving kinematic system zones, for example cuboids or spheres, from safe axis positions. The zones are parameterized such that they contain the moving parts of the kinematic system completely, forming so-called enveloping bodies. A check is then performed for each kinematic system zone to determine whether it leaves a previously defined, fixed operating space zone or whether it overlaps at least one previously defined, fixed protection zone. The leaving of the operating space or an overlap with protection zones is indicated using safe outputs.

Furthermore, the function of monitoring a safe orientation is known. The orientation of a previously stipulated axis, for example an orientation of a blade mounted at the tool center point, is calculated from safe axis positions. This orientation is compared with a setpoint value and the difference is output at a safe output.

An end user may connect up the safe outputs to functions that activate a suitable safety reaction, for example initiate stopping of a machine or activate a speed restriction.

Safe monitoring is normally based on safe positions of the individual axes as the basis for the output and if necessary, the initiation of a safety reaction. The positions of the individual axes may be ascertained only with a specific accuracy deviation. Sensor values are erroneous in practice. Such errors need to be reproduced by the safety function. Inaccuracies also arise as a result of inertias and run-on distances caused thereby.

Known conventional statistical error calculation, for example based on guide of uncertainty in measurements (GUM) methods, does not make satisfactory allowance for the errors that occur, since mean deviations are calculated here, rather than a worst-case deviation.

It is furthermore known practice to use merely general correction values without knowledge of the specific kinematic system that is in use, with its data and the quality of the sensors used. The specification of general correction values of this kind needs to be very conservative for safety-oriented operation, that means that the availability of the multi-axis kinematic system is often unnecessarily reduced during use.

### BRIEF SUMMARY AND DESCRIPTION

The scope of the present disclosure is defined solely by the appended claims and is not affected to any degree by the statements within this summary. The present embodiments may obviate one or more of the drawbacks or limitations in the related art.

Embodiments improve allowance made for errors during the safe monitoring of multi-axis kinematic systems.

Embodiments provide a method for setting up safe operation of a multi-axis kinematic system. The safe operation includes a safety function, the safety function being based on respective axis positions of respective axes of the multi-axis kinematic system, including the following steps: providing error values of respective axes, ascertaining a compensation value for at least one variable of the safety function on the basis of the error values, on the basis of geometric parameters of the multi-axis kinematic system and on the basis of axis values of the respective axes that are obtained from trajectories of the multi-axis kinematic system.

The error values of axes that are involved are known. The error values are the error values that are relevant to a specific application or a specific design or a specific installation using the multi-axis kinematic system, for example axial error values, that may be sensor resolutions, run-on distances, etc. An axial error value is relevant if it is necessary to make allowance for it in order to apply a safety function, for example because it affects the actual Cartesian position, speed or orientation that is monitored. An error value exists if there is a deviation between the actual position, speed, or orientation of the axes of the multi-axis kinematic system and positions, speeds or orientations that are reported by sensors, or setpoint positions, setpoint speeds or setpoint orientations that are predefined on the basis of control commands. Allowance is made for this error value, that for example is attached to input variables of the safety function, in the safety function by the ascertained Cartesian compensation value.

Depending on which axes need to be monitored in order to perform safe operation, only these axes need to have the associated error values specified for them. For example, all axes of a multi-axis kinematic system to be monitored that are involved are relevant to the safety monitoring, and for example maximum error values of all existing axes are provided.

Error values are normally known to a mechanical engineer or end customer or to an integrator. A software tool, for example integrated in a widely used engineering environment, allows the known error values to be provided by the end customer or mechanical engineer themself. By way of example, the method is carried out during a configuration or engineering phase.

The compensation value is ascertained by using not only the provided error values but also geometric parameters of the multi-axis kinematic system. This allows kinematic-system-specific ascertainment of the compensation value, that results in allowance being made for the errors that actually affect the specific kinematic system. Depending on the task and purpose of use of multi-axis kinematic systems, the systems differ from one another in their geometric parameters. By way of example, the lengths of linear axes, the inclination thereof, the number of axes operated in succession, the arrangement of parallel axes, etc., are optimized for the purpose of use of the kinematic system.

The geometric parameters may also not be available until in a configuration phase of a user, for example an end customer, mechanical engineer or integrator, which means that making allowance for a kinematic-system-specific compensation value in the actual safety function that is delivered to the user, for example as software, is barely possible. Making allowance for the geometric parameters that apply in the specific case allows the compensation value to turn out not too pessimistically.

In the configuration phase, it is furthermore possible to deduce which trajectories are relevant to the multi-axis kinematic system, for example which trajectories may be expected during operation. It is therefore possible to ignore errors that could potentially arise on the basis of combinations of axis positions if the combinations are not adopted on the basis of the trajectories.

As a rule, multiple variables are monitored by a safety function during operation, for example the positions of multiple moving axes and for example, furthermore, positions and speeds of each of multiple moving axes. By way of example, different attitudes adopted while taking one or more trajectories bring about different, in each case current, compensation values. By way of example, different deviations in respective positions or speeds or orientations of the axes involved occur for every trajectory for every axis over the course of movement along the trajectory on account of the error propagation or deviation propagation. Error ascertainment may for example involve ascertaining the maximum deviation that occurs for every trajectory or as a whole for all trajectories for a variable of the safety function. This maximum possible error for the specific kinematic system on the basis of sensor errors or run-on distances may be ascertained in the configuration phase, for example, and used by the safety function in a later operating phase. By way of example, multiple compensation values are ascertained for multiple trajectories and stored for later use.

The ascertained compensation values are compensation values for which allowance needs to be made for every axis or for every segment, for example. Maximum lengths by which monitoring zones need to be enlarged for every segment, or maximum speed absolute values by which intended Cartesian speed limits need to be reduced, may therefore be ascertained for operation, for example. Furthermore, the ascertained compensation values are used for example to enlarge static zones that apply to the whole kinematic system in the case of protection zones or to reduce them in the case of operating zones.

The ascertained compensation values correspond to values of variables to be monitored that compensate for the possible errors or deviations that occur.

The proposed method therefore succeeds in ascertaining a compensation value for a variable of a safety function individually for a kinematic system, including the axis sensors thereof that are affected by uncertainties, or run-on behaviors, and for the envisaged trajectories that may be traveled along by the specific kinematic system.

The ascertained compensation value may be used to set up safe operation in such a way that allowance is also made for inaccuracies in detected positions, that affect variables of an intended safety function, or deviations on account of axial run-on distances. At least one variable of a safety function, for example a dimension of a zone or orientation of an axis or position and/or speed of a point on the kinematic system, is therefore extended by a compensation value. The safety monitoring then uses the at least one variable in due consideration of the ascertained compensation value.

Excessively pessimistic allowance for errors, as is the case with an approach that applies to a multiplicity of kinematic systems, for example, is firstly avoided; secondly, it is provided that the safety function makes allowance for all errors relevant to a specific kinematic system on the basis of combinations and trends of axis positions on the basis of the trajectories.

By way of example, when ascertaining the compensation values, allowance is also made for numerical errors that arise for example as a result of approximative algorithms, iterative methods, roundings, for example in floating-point or fixed-point arithmetic.

According to one configuration, sensor resolutions of respective axis sensors are provided as the error values. The axis sensors are for example transducers provided on the respective axes. The error values provided are for example maximum sensor errors that are possible for every axis sensor. Ascertaining the compensation value on the basis of the sensor resolutions and the geometric parameters of the multi-axis kinematic system and the axis values of the respective axes that are obtained from trajectories of the multi-axis kinematic system provides safe operation of the multi-axis kinematic system, in which, in the course of operation of the kinematic system, the variables of safety functions, for example safety zone variables, are afforded sufficiently large proportions in due consideration of the compensation value, and at the same time does not necessitate excessively pessimistic allowance being made for sensor errors. Sensor errors or inaccuracies on the basis of sensor resolutions for which allowance needs to be made during later operation are advantageously already ascertained in a setup phase.

According to one configuration, axial run-on distances are provided as the error values. The run-on distances are for example dependent on the effective axis inertia or axis load or on the axis speed. By way of example, axial run-on distances are specified in table form. A relevant worst-case value is then specified for every axis, for example, or a dependency of a run-on distance on further axis properties is stored, so that for example automatic or dynamic adaptation may take place.

A compensation value for which allowance needs to be made when performing safety functions may therefore advantageously be ascertained in the setup phase. By way of example, a variable of a safety function, for example a safety zone variable, is adapted so that safety reactions, such as e.g., a safe stop, are also reliably performed in due consideration of the run-on distances. Advantageously, and for example in addition to the allowance made for sensor resolutions, allowance is therefore made for uncertainties and deviations from setpoint values that occur during operation after a safety reaction is initiated.

Depending on which masses, inertias and speeds prevail on axes, the compensation effects on the basis of axial run-on distances or sensor resolutions may be predominant. Advantageously, both effects are ascertained, and allowance is ultimately made for the resulting maximum compensation values.

According to one configuration, the geometric parameters of the multi-axis kinematic system are further provided for the setup. A user predefines geometric parameters of the specific multi-axis kinematic system within a configuration process that takes place for example when a machine is started up or during equipment modification. By way of example, they provide the parameters by a user interface of the engineering program.

By way of example, the parameters relate to lengths of different segments of a multi-axis kinematic system or to the intended number of linear or parallel axes and to the intended number of rotary axes, etc. The geometric parameters themselves may also be erroneous. This error contribution may also be used for ascertaining the compensation value.

According to one configuration, the trajectories are deduced from a set of trajectories that are predefinable for the multi-axis kinematic system. In a configuration phase before actual operation of the kinematic system, the trajectories for which the kinematic system is supposed to be suitable during later operation and that it is meant to travel along by motion control are stipulated. This involves predefining for example a multiplicity of trajectories that are traveled along by the kinematic system alternatively or alternately. Moreover, slightly differing kinematic systems may be stored in order to be able to allow tolerances during later operation.

According to one configuration, the trajectories are deduced from maximum value ranges for the respective axes. In this configuration, a multiplicity of trajectories are deduced from the maximum value ranges of the axes of the kinematic system. If the respective maximum value range is known for all axes involved in a specific multi-axis kinematic system, for example, then all conceivable combinations of axis attitudes may be ascertained and compensation values for the variables that are of interest to the safety function may be calculated for each of these possible combinations. By way of example, maximum compensation values to be expected may thus be determined for all possible attitudes and hence all possible movements or trajectories in advance, i.e., before operation of the multi-axis kinematic system, and then included in the compensation for variables of the safety function.

As such, compensation values that depict the worst case for the specific kinematic system and the specific error values of the individual sensors are for example calculated in advance for intended monitoring zones or monitoring segments. By way of example, monitoring zones are thus enlarged, or limit speeds are reduced, in order to be able to adopt all conceivable kinematic system attitudes without risk during later operation in a motion sequence or after the initiation of a safety reaction. The introduction of new motion sequences is therefore also possible without renewed ascertainment of compensation values.

According to one configuration, the trajectories describe a combination of axis values of all axes over a time and are formed for example on the basis of a trace or a simulation or an observation of live data during a movement of the multi-axis kinematic system. A trace in this case describes positions of all axes at different times. The times are at flexible intervals of time close to one another. Data from axis positions that are obtained from test runs or from motion sequences performed for other kinematic systems of the same design are collected and stored over time in a trace. Depending on the time resolution used to detect axis positions, combinations of axis positions are stored at corresponding intervals of time. By way of example, a trace is provided in a CSV file format.

A simulation results in the time resolution with which a simulation result is supposed to be calculated being stipulated. If required, data relating to approximately continuous motion sequences are therefore available. A simulation may also be provided as a CSV file.

Advantageously, the compensation values on the basis of the axis sensor errors and the error propagation or run-on distances thereof and the deviation propagation thereof are ascertained for motion sequences tailored to the kinematic system, and therefore unnecessarily pessimistic estimation of compensations is avoided. Compensations of monitoring zones or speeds or angles that could arise on the basis of motion sequences that the kinematic system will not perform during operation may advantageously be ignored for adapting the safety function.

According to one configuration, the safety function includes safe zone monitoring, a safe orientation and/or a safe Cartesian speed. The safe zone monitoring results in zones that surround or envelop moving sections of the kinematic system being predefined. The safe axis positions may be used to infer the position and orientation of these zones. The ascertained zones are then examined for whether they leave the operating space zones defined for the kinematic system. If such a state is detected, a safety function is triggered, that may be a safe stop or a reduced speed, for example.

Similarly, collision monitoring takes place using protection zones defined in the operating environment of the kinematic system, and a safety function is triggered if the two zones overlap, for example the kinematic system zone overlaps the protection zone. By way of example, the zone monitoring is configured, and for example the zone size is dimensioned, in such a way that even if a safety reaction has been triggered, such as a safe stop, the operating space zone is not left or an overlap with a protection zone is prevented.

According to one configuration, a position error absolute value, an angle error absolute value and/or a speed error absolute value are ascertained as the compensation value. The compensation value may therefore be ascertained in order to carry out compensation for variables that are used by the safety function in order to monitor when specific limit values are exceeded or fallen short of. By way of example, positions of axes or angles or orientations of axes and therefore for example of tools or other parts on the end effector are complemented by the associated compensation value.

The compensation value is advantageously already the value by which the safety function is adapted without further calculations. By way of example, it is directly a length by which monitoring zones need to be enlarged or operating zones need to be reduced. By way of example, it is angles for which allowance needs to be made in the safety function Safe orientation in order to reliably compensate for the axis errors. Furthermore, it is speed absolute values by which speed limit values that must not be exceeded need to be reduced, for example. In the case of speed limit values, it should be noted that speeds are normally calculated on the basis of at least two axis positions, and the limit value needs to be set lower in due consideration of the errors and the propagation thereof.

According to one configuration, a timing error for the scanning of respective axis sensors over time is further provided. Allowance may therefore be made for an offset in the scanning over time, and hence further inaccuracies of the axis sensors. If the maximum axis speeds are known, the offset may be used to calculate an additional position error, that is likewise used for ascertaining the compensation value.

According to one configuration, maximum dynamic values of the respective axes are further provided. By way of example, a maximum speed of an axis is predefined, or acceleration ranges of axes. Together with predefined value ranges, the ascertainment of the compensation value is therefore configured even more specifically for the kinematic system, and unnecessarily high compensations may advantageously be avoided. By way of example, the predefining of a limited speed leads to a shorter run-on distance for the respective axis.

According to one configuration, further parameters or the maximum dynamic values are ascertained during operation of the multi-axis kinematic system. Advantageously, the further parameters or maximum dynamic values may be ascertained in a test run or may be examined during operation at the run time. If deviations come to light, the compensation value may be ascertained again in order to avoid a safety risk.

According to one configuration, the safety function is adapted on the basis of the compensation value. As soon as the maximum error values and also the geometric parameters and the trajectories for the specific multi-axis kinematic system have been provided or are known, the compensation value may be ascertained, and the safety function then makes allowance for the compensation value for one or more variables of the safety function, depending on the intended safety function.

If there is provision for zone monitoring, for example, the position error that arises for the different segments of the kinematic system and an orientation error, for example of the end effector, are ascertained. Both error values act as a compensation value for the variables that are monitored by the safety function, in this example for the dimensions of zones.

This adaptation may be performed automatically by the safety function. By way of example, a software tool in the engineering, that also forms the interface for the user to input the data, informs the user only about the adaptation performed. As soon as a compensation value is available for the function, the variables or limit values to be monitored are adapted as appropriate. If there is provision for speed monitoring, a speed error is calculated for multiple monitoring points on the basis of the position errors thereof, and the speed error is taken into account when setting up a limit speed. Furthermore, an ascertained orientation error may be used for orientation monitoring and may reduce a limit angle by the appropriate compensation value.

According to one configuration, the compensation value for the at least one variable is ascertained and stored on the basis of an adoptable attitude or position of the multi-axis kinematic system. A compensation is accordingly not calculated globally and applied as standard for all of the movement of the kinematic system, but rather a table is created, for example, in which various kinematic system positions or ranges of kinematic system positions are assigned a compensation value. This approach may be regarded as creating an accuracy map. As a result, for example a high compensation value is used only if the kinematic system is also in the range of travel in which correspondingly large errors or axial run-on distances may potentially arise. The accuracy map is for example stored in the kinematic system coordinate system, i.e., with reference to the kinematic system origin in the world coordinate system, i.e., with reference to a surroundings system in which the robot operates, or directly on the basis of the axis attitudes.

According to one configuration, the safety function is adapted during operation on the basis of the compensation value and a current attitude or position of the multi-axis kinematic system. A stored accuracy map is advantageously used during operation to apply the, in each case currently, sufficiently high compensation value, which at the same time is optimized and avoids unnecessary restrictive compensations.

According to one configuration, during operation the safety function resorts to compensation values that have been determined using one of the methods described above. Optimized safety operation is therefore ensured, that is optimized in respect of necessary error compensation and unnecessarily generalized error estimation. The safety function is complemented, for example in the engineering, by the ascertained compensation values for all variables of the safety functions, for example position errors, orientation errors and speed errors. The variables such as monitoring zones, limit speeds and limit angle deviations are adapted by the applicable compensation values from position and angle errors and the error propagation thereof or from axial run-on distances and the potential propagation thereof. During operation, zone monitoring, orientation monitoring and speed monitoring are then performed using the adapted variables.

Embodiments include an input device for setting up safe operation of a multi-axis kinematic system, wherein the safe operation includes a safety function, wherein the safety function is based on respective positions of respective axes of the multi-axis kinematic system, including an input, for example an HMI-based input, for inputting compensation values of respective axes, and an output for outputting a compensation value for at least one variable of the safety function on the basis of the compensation values, on the basis of geometric parameters of the multi-axis kinematic system and on the basis of axis values of the respective axes that are obtained from trajectories of the multi-axis kinematic system.

Embodiments include a computer program product including commands that, when the program is executed by a computer, cause the computer to perform the method according to one of the configurations described above.

A computer program product, such as e.g., a computer program, may be provided or delivered as a storage medium, such as e.g., a memory card, USB stick, CD-ROM, DVD, or in the form of a downloadable file from a server in a network. This may be affected in a wireless communication network, for example, by virtue of the transmission of an appropriate file containing the computer program product or the computer program. Suitable computers are any program-controlled device, for example a control device, such as for example a microprocessor, or an industrial PC.

### BRIEF DESCRIPTION OF THE FIGURES

FIG. 1 depicts a schematic representation of an input device according to an embodiment.

FIG. 2 depicts a schematic flowchart to illustrate the method according to an embodiment.

FIG. 3 depicts a schematic representation of a multi-axis kinematic system to illustrate the method according to an embodiment.

In the figures, elements that have the same function have been provided with the same reference symbols unless indicated otherwise.

### DETAILED DESCRIPTION

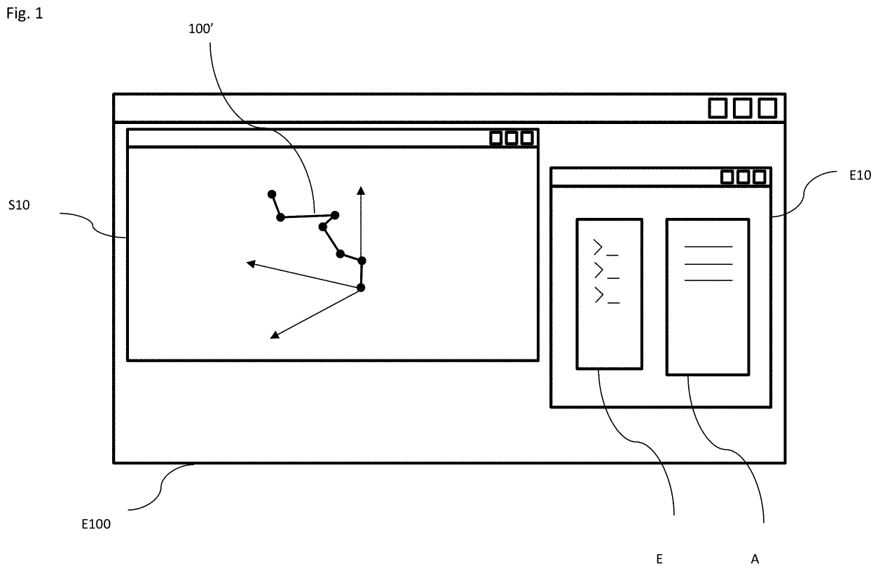

FIG. 1 depicts a realization of an input device EH) according to an embodiment that is realized for example as a graphical user interface on an HMI. By way of example, this is a window-based solution that is integrated in an engineering tool E100 in terms of design and handling. The engineering tool E100 is used in the normal way to configure an application scenario in which a multi-axis kinematic system is used. The multi-axis kinematic system is used in an application for example to perform machining of a workpiece using a tool mounted on the end effector of the multi-axis kinematic system. In the configuration phase for this application, for example data of the multi-axis kinematic system and surroundings data are captured in the engineering tool, and a wide variety of functions are set up. By way of example, function modules are used to set up motion sequences that need to be performed by the kinematic system during operation.

Furthermore, monitoring functions are also set up here. By way of example, zones through which the kinematic system is not supposed to travel, as safety zones in the surroundings of the kinematic system, are predefined. For a monitoring function, for example operating zones are stipulated that envelop individual segments of the multi-axis kinematic system with predefined geometric bodies and that define spaces that are likewise not permitted to overlap safety zones.

Such safety functions are defined during the configuration by the engineering tool E100. By way of example, there is provision for producing a simulated representation of a multi-axis kinematic system 100′ in a visualization window S10 and using this to visualize the application scenario, for example including an environment. By way of example, it is thus possible to simulate the execution of motion sequences in the space in due consideration of an environment and defined safety and operating zones. It is furthermore also possible here to simulate safety reactions such as the initiation of safe stop processes.

The safety functions defined by the engineering tool are based on position data that the safety functions obtain from axis sensors of the various driven axes of the multi-axis kinematic system. A crucial aspect for safety on an installation is therefore the reliability of the position data obtained. For this purpose, there is provision for standard safety mechanisms, for example in order to react to failure of a sensor as appropriate.

Another crucial aspect for safety is that there is an opportunity to make allowance for axial run-on distances.

There is thus provision for the input device E10, that has an input E or an input mask. There, there is provision for an input facility for the user in order to input error values from axis sensors on the basis of axial run-on distances.

Depending on the design of the engineering tool E100, geometric parameters of the multi-axis kinematic system are configured at another location already. By way of example, these data are also needed for motion planning that creates the trajectories for the multi-axis kinematic system. Similarly, however, it is also possible for these geometric parameters to be predefined separately for the input device E10 by the user by the input E in order to set up safe operation.

The input device E10 serves as an interface that the user may use to make all the necessary inputs so that a software program running at the time of configuration may calculate compensation values therefrom. These compensation values are in different forms, depending on the safety functions that are configured. For the zone monitoring described above, compensation values for all zones to be monitored are output as the compensation values via the output A. By way of example, the length absolute value by which dynamic zones or segment zones that are involved need to be enlarged, along individual coordinate directions, depending on the instance, so as, even in the event of a safety reaction that leads to run-on distances for single or multiple axes, to reliably compensate for this uncertainty regarding the actual position of the axes, is therefore specified.

By way of example, the input device E10 is configured in such a way that maximum possible run-on distances of all axes involved are entered. Depending on which safety functions have already been configured, all compensation values for which allowance needs to be made in the respective safety functions are accordingly now output. If for example the function “Safe orientation” has additionally been configured, the input field is used to record a run-on distance in the form of an angle error, that may occur for a rotary axis on the basis of the inertia, for the rotary axis that is to be monitored using the safety function “Safe orientation” and accordingly to specify a compensation value in the form of a compensation angle that describes a spherical segment as a tolerance range.

Additionally, allowance may also be made for erroneous variables. Position data obtained by axis sensors are typically erroneous variables of this kind. Since the ascertainment of positions of an end effector or of individual segments of the multi-axis kinematic system often involves output data from multiple different axis sensors, it is also necessary to make allowance for the interaction of error contributions by multiple sensors or transducers. Depending on which masses, inertias and speeds may prevail on axes, the compensation effects on the basis of axial run-on distances or sensor resolutions may be predominant. Advantageously, both effects are ascertained, and allowance is ultimately made for the resulting maximum compensation values.

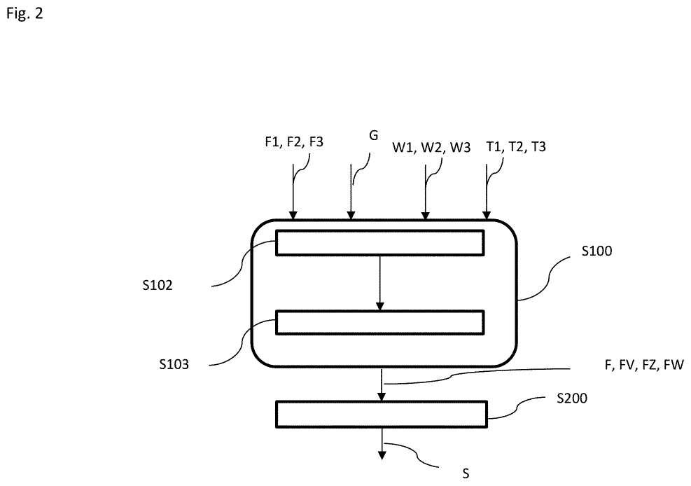

FIG. 2 uses a flowchart to illustrate a method according to an embodiment. In a first step, setup S100 takes place, at the end of which a compensation value F is output. On the basis of this compensation value F, safe operation S200 of the multi-axis kinematic system is rendered possible in a second step. During operation, at least one safety function S is in operation. By way of example, the function “Safe speed monitoring” is activated, that predefines maximum speeds for individual axes and initiates a safety state if the maximum speed is exceeded. By way of example, the exceeding is indicated at an output or stopping of the kinematic system is initiated, a so-called STO.

Allowance is made for a speed, determined using sensors or transducers, of individual axes, or of a part of the multi-axis kinematic system whose speed results from the interaction of multiple axes, being erroneous. Positions detected at predefined times are used for the speed ascertainment. The positions are erroneous and accordingly the speed deduced therefrom is also erroneous.

As part of the setup S101, the errors attached to the two items of position information are used to ascertain S103 the compensation value F, here inter alia a speed error absolute value FV of the speed, using the methods of error propagation. The absolute value is just large enough for the worst case of errors adding up to be covered and at the same time excessively pessimistic estimation not to take place.

To again correctly ascertain the position errors attached to the part of the kinematic system that is monitored using the function “Safe speed”, for example the end effector, the position errors of all axes involved, or of the respective axis sensors thereof, are ascertained and then propagation algorithms are used to ascertain an error of the respective position. For this purpose, a software program that performs the ascertainment of the error absolute values in the setup phase is provided S102 with the maximum position errors of the axes involved as maximum error values F1, F2, F3. Besides the position error on the basis of the output value of the sensors, errors for the scanning of the sensors over time are also included. For every position detected at a time, a total position error absolute value FZ is therefore obtained. Allowance is accordingly made for respective total position errors in order to ascertain the speed error absolute value FV.

The total position error absolute value FZ may also be used for further activated safety functions, for example in order to estimate the position errors, that are critical for the zone monitoring and necessitate enlargements of the safety zones. For an additional activated safety function “Safe orientation”, an angle error absolute value FW may additionally be output, that defines the cone within which the orientation of a tool or other part of the kinematic system may be expected in the worst case.

Besides the maximum errors F1, F2, F3, the geometric parameters G of the multi-axis kinematic system are also provided to the input device. Moreover, trajectories T1, T2, T3 are provided that describe the relevant trajectories of the multi-axis kinematic system during later operation.

For scenarios in which the trajectories to be taken later are not yet known at the time at which safe operation is set up, maximum value ranges W1, W2, W3 for axes 1, 2, 3 that are involved are provided. By way of example, a maximum linear range of travel of a linear axis is specified, and also maximum angles describing the swivel range, in one or more directions, of rotatably mounted axes that are involved. These details may be used in the setup phase to deduce all attitudes of the multi-axis kinematic system that are potentially adoptable during operation.

All of the details made available in this manner may now be used to provide the error absolute values in a manner tailored to an individual kinematic system and the individual intended motion sequences thereof. For example, an error absolute value for a variable is output as the maximum error absolute value obtained while traveling along a trajectory T1. The absolute value may then be filed or stored with reference to the trajectory T1. In other variants, the maximum error absolute value is ascertained for all possible trajectories. In this case, it is not necessary to distinguish between error values of different trajectories during later operation, but an excessively pessimistically calculated error may be involved.

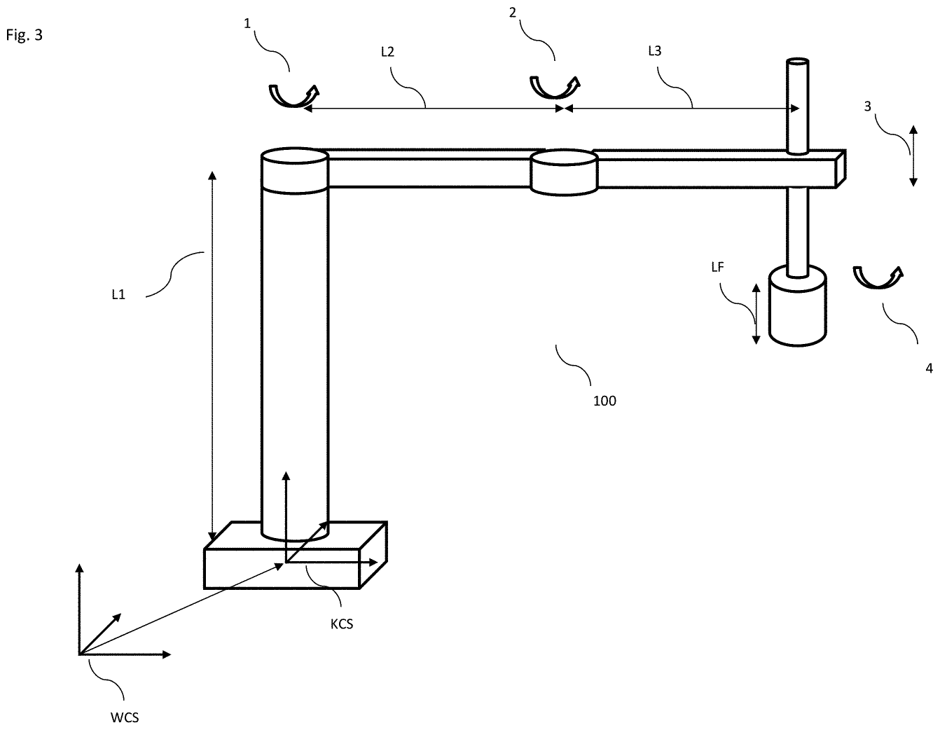

FIG. 3 schematically depicts a multi-axis kinematic system 100 with a kinematic system coordinate system KCS referenced to the kinematic system and a world coordinate system WCS of the surroundings. There is provision for a first axis 1 as a rotary axis, which is situated at the end of a first segment L1, the alignment of which coincides with that of a vertical axis of the kinematic system coordinate system. A user inputs the length of the first segment L1, and also the length of the second segment L2 and the length of the third segment L3, as geometric parameters of the multi-axis kinematic system 100. The second segment L2 starts from the first rotary axis 1 and is connected to the third segment L3 by way of a further rotary articulation, that forms the second axis 2. There is moreover provision for a lifting axis 3 on the third segment, that may be moved vertically. Finally, a last axis 4 is set up as a rotatable axis, that at the same time forms a flange having the dimension LF, for example.

The user also predefines the following transducer errors as maximum error values:

transducer error F1 axis 1: 1/10°
transducer error F2 axis 2: 1/10°
transducer error F4 axis 4: 1/10°
transducer error F3 axis 3: 1 mm

The errors in the input angles and the input parameters propagate to the calculated position of the flange as follows and produce a Cartesian position error Fpos of the flange:

Fpos=Fa1+Fa2+Fa3

where Fa1, Fa2, Fa3 are the error contributions of the axes 1, 2, 3, that all add up.

The following derivation may be used for the error contribution Fa2:

Let there be a position vector v, that is rotated about an angle α. An angle deviation of e_{α} leads to a position error F=∥v−v′∥ of no more than

$$2 * sin ( \frac{{e}_{α}}{2} ) * ‖ v ‖ .$$

If α is specified in degrees, it holds that

$$F < 2 * sin ( \frac{{e}_{α}}{2} ) * ‖ v ‖ .$$

This is true because the incorrect position v′ and the correct position v and also the center of rotation form an isosceles triangle with acute angle e_{α}.

In vector terms, the following is therefore obtained for Fa2 on the basis of the axis values a1 and a2:

$$F a 2 = 2 * sin ( \frac{F 2 * π}{360} ) * L 3 * ( \begin{matrix}\begin{matrix}\vert sin ( a 1 + a 2 ) \vert \\ \vert cos ( a 1 + a 2 ) \vert\end{matrix} \\ 0\end{matrix} )$$

The error contribution Fa1 is obtained analogously as:

$$F a 1 = 2 * sin ( \frac{F 1 * π}{360} ) * ( L 2 * ( \begin{matrix}\begin{matrix}\vert sin ( a 1 ) \vert \\ \vert cos ( a 1 ) \vert\end{matrix} \\ 0\end{matrix} ) + L 3 * ( \begin{matrix}\begin{matrix}\vert sin ( a 1 + a 2 ) \vert \\ \vert cos ( a 1 + a 2 ) \vert\end{matrix} \\ 0\end{matrix} ) )$$

In this case, the superposition principle is used for multiple erroneous inputs to add the values in the outputs.

The error contribution Fa3 of (linear) axis 3 is used directly in the z component of the total position error:

$$Fa 3 = ( \begin{matrix}0 \\ 0 \\ F 3\end{matrix} )$$

Additionally, an absolute value estimation may take place across all possible axis input values, that means that the following is obtained for the example indicated:

$$‖ Fpos ‖ \leq ‖ Fa 1 ‖ + ‖ Fa 2 ‖ + ‖ Fa 3 ‖ \leq 2 * sin ( \frac{100 * π}{360000} ) * ( 600 mm ) + 2 * sin ( \frac{100 * π}{360000} ) * ( 300 mm ) + 1 mm = 2.570796 mm$$

Since safe zone monitoring is supposed to be active for the kinematic system depicted by way of illustration, for example a Scara robot, the radii or cuboid half-lengths of intended kinematic system protection or operating spaces are adapted by the value Fpos. For higher accuracy requirements, the individual half-lengths may also be individually adapted in due consideration of the relevant axis attitudes.

Additionally, a safety function is also set up that reliably monitors the orientation of the flange.

Errors propagate from the error contributions F1, F2, F4 to the calculated orientation in an unaltered manner. In the worst case, the error Frot is therefore obtained for the given kinematic system values:

$$Frot = \frac{{100}^{°} + {100}^{°} + {100}^{°}}{1000} = \frac{{300}^{°}}{1000}$$

The compensation value Frot is also used by the monitoring function to perform an adaptation of the limit value. In this case, the spherical segment within which the orientation of the flange must be situated in order for no safety function to be initiated is reduced in the engineering as appropriate.

If speed monitoring is additionally active as a safety function, the speed of a point is obtained analogously from the result of the vector subtraction from the most recently calculated position and a current position in due consideration of the time that has elapsed. Allowance is accordingly made for the errors additively for the worst case in order to adapt the limit speed as appropriate.

The proposed method and the proposed input device are used to provide a user of a safety-monitored multi-axis kinematic system with a simple and less error-susceptible way of setting up compensations during safety monitoring that make allowance for sensor-related errors or axial run-on distances, and at the same time ensure only the minimum necessary compensation. Embodiments may advantageously be used for SCARA robots, a Cartesian portal, a roller picker, a swivel arm, arbitrary serial kinematic systems, or parallel kinematic systems. If an accuracy map is additionally used, the average compensation may be reduced further still.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for setting up a safe operation of a multi-axis kinematic system, wherein the safe operation comprises a safety function that is based on respective axis positions of respective axes of the multi-axis kinematic system, the method comprising:
providing error values of respective axes; and
ascertaining a compensation value for at least one variable of the safety function on the basis of the error values, on the basis of geometric parameters of the multi-axis kinematic system, and on the basis of axis values of the respective axes that are obtained from trajectories of the multi-axis kinematic system.

2. The method of claim 1, wherein sensor resolutions are provided as the error values of respective axes.

3. The method of claim 1, wherein axial run-on distances are provided as the error values of respective axes.

4. The method of claim 1, wherein the geometric parameters of the multi-axis kinematic system are further provided for the setup.

5. The method of claim 1, wherein the trajectories are deduced from a set of trajectories that are predefinable for the multi-axis kinematic system.

6. The method of claim 1, wherein the trajectories are deduced from maximum value ranges for the respective axes.

7. The method of claim 1, wherein the trajectories describe a combination of axis values of all axes over a time and are formed on the basis of a trace or a simulation or an observation of live data during a movement of the multi-axis kinematic system.

8. The method of claim 1, wherein the safety function comprises at least one of a safe zone monitoring, a safe orientation, or a safe Cartesian speed.

9. The method of claim 1, wherein at least one of a position error absolute value, an angle error absolute value, or a speed error absolute value are ascertained as the compensation value.

10. The method of claim 1, wherein a timing error for scanning of respective axis sensors over time is further provided.

11. The method of claim 1, wherein maximum dynamic values of the respective axes are further provided.

12. The method of claim 1, wherein further parameters or the maximum dynamic values are ascertained during operation of the multi-axis kinematic system.

13. The method of claim 1, wherein the safety function is adapted on the basis of the compensation value.

14. The method of claim 1, wherein the compensation value for the at least one variable is ascertained and stored on the basis of an adoptable attitude or position of the multi-axis kinematic system.

15. The method of claim 14, wherein the safety function is adapted during operation on the basis of the compensation value and a current attitude or position of the multi-axis kinematic system.

16. The method of claim 1, wherein during operation the safety function resorts to the ascertained compensation values.

17. An input device for setting up a safe operation of a multi-axis kinematic system, wherein the safe operation comprises a safety function that is based on respective axis positions of respective axes of the multi-axis kinematic system, the input device comprising:
an HMI-based input configured to input error values of respective axes; and
an output configured to output a compensation value for at least one variable of the safety function based on the error values, geometric parameters of the multi-axis kinematic system, and axis values of the respective axes that are obtained from trajectories of the multi-axis kinematic system.

18. A non-transitory computer implemented storage medium that stores machine-readable instructions executable by at least one processor, the machine-readable instructions for setting up a safe operation of a multi-axis kinematic system, wherein the safe operation comprises a safety function that is based on respective axis positions of respective axes of the multi-axis kinematic system, the machine-readable instructions comprising:
providing error values of respective axes; and
ascertaining a compensation value for at least one variable of the safety function on the basis of the error values, on the basis of geometric parameters of the multi-axis kinematic system, and on the basis of axis values of the respective axes that are obtained from trajectories of the multi-axis kinematic system.
